(19) United States
(12) Patent Application Publication
(10) Pub. No.: US 2012/0225627 A1
(43) Pub. Date: Sep. 6, 2012

(54) SEMICONDUCTOR SWITCH AND WIRELESS DEVICE

(75) Inventor: Toshiki Seshita, Kanagawa-ken (JP)

(73) Assignee: KABUSHIKI KAISHA TOSHIBA, Tokyo (JP)

(21) Appl. No.: 13/234,018

(22) Filed: Sep. 15, 2011

(30) Foreign Application Priority Data
Mar. 4, 2011 (JP) 2011-047817

(51) Int. Cl. H01Q 23/00; H04B 1/38; G05F 1/10

(52) U.S. Cl. 455/90.2; 327/109

(57) ABSTRACT

According to one embodiment, a semiconductor switch includes a power supply, a driver, a switch section, and a compensator. The power supply is configured to generate a first potential different from a power supply potential. The driver is configured to be supplied with a second potential different from the first potential and the first potential and output at least one of the first potential and the second potential according to a terminal switching signal. The switch section is configured to switch a connection between a common terminal and a radio frequency terminal according to an output of the driver. The compensator is configured to detect a change in the terminal switching signal and supply electric charges having a polarity the same as a polarity of the first potential to the driver for compensating the first potential.

### CROSS-REFERENCE TO RELATED APPLICATIONS

This application is based upon and claims the benefit of priority from the prior Japanese Patent Application No. 2011-047817, filed on Mar. 4, 2011; the entire contents of which are incorporated herein by reference.

### FIELD

Embodiments described herein relate generally to a semiconductor switch and a wireless device.

### BACKGROUND

Semiconductor switches to open and close a circuit can be used for various electronic devices. For example, in a radio frequency circuit of a mobile phone, a transmitting circuit and a receiving circuit are selectively connected to a common antenna through a radio frequency switch circuit. For a switch element of a radio frequency switch circuit like this, a MOSFET (Metal Oxide Semiconductor Field Effect Transistor) formed on a SOI (Silicon On Insulator) substrate is used.

The FET has non-linearity because the FET is a semiconductor device, and it is necessary to apply an appropriate voltage to the amplitude of input power in order to decrease a distortion. However, from a viewpoint of downsizing, the current supply capacity of a power supply has limitations in the case where an ON voltage or an OFF voltage is internally generated. Thus, in switching operations, the absolute value of a voltage may be decreased and a distortion immediately after switching may be increased.

### BRIEF DESCRIPTION OF THE DRAWINGS

FIG. 1 is a block diagram illustrating a configuration of a semiconductor switch according to a first embodiment;

FIG. 2 is a circuit diagram illustrating a configuration of a switch section of the semiconductor switch shown in FIG. 1;

FIG. 3 is a characteristic diagram showing the dependence of a third-order harmonic distortion on a Off-potential Voff of the switch section shown in FIG. 2;

FIG. 4 is a circuit diagram illustrating a configuration of an interface and a driver of the semiconductor switch shown in FIG. 1;

FIG. 5 is a circuit diagram illustrating a configuration of a level shifter;

FIG. 6 is a circuit diagram illustrating a configuration of a power supply of the semiconductor switch shown in FIG. 1;

FIG. 7 is a circuit diagram illustrating a configuration of a compensator of the semiconductor switch shown in FIG. 1;

FIG. 8 is a circuit diagram illustrating a configuration of a edge detector shown in FIG. 7;

FIG. 9A, FIG. 9B, and FIG. 9C show timing charts of main signals of the edge detector illustrated in FIG. 8;

FIG. 10 is a circuit diagram illustrating a configuration of an amplifier shown in FIG. 7;

FIG. 11 is a waveform diagram showing time variations in a first potential Vn of the semiconductor switch according to the first embodiment;

FIG. 12 is a block diagram illustrating a configuration of a semiconductor switch according to a second embodiment;

FIG. 13 is a block diagram illustrating a configuration of a semiconductor switch according to a third embodiment;

FIG. 14 is a circuit diagram illustrating a configuration of a compensator of the semiconductor switch shown in FIG. 13;

FIG. 15 is a circuit diagram illustrating a configuration of an amplifier shown in FIG. 14;

FIG. 16 is a block diagram illustrating a configuration of a wireless device according to a fourth embodiment;

FIG. 17 is an equivalent circuit diagram illustrative of variations in a first potential Vn in a comparative example; and

FIG. 18 is a waveform diagram showing time variations in the first potential Vn of the semiconductor switch of the comparative example.

### DETAILED DESCRIPTION

In general, according to one embodiment, a semiconductor switch includes a power supply, a driver, a switch section, and a compensator. The power supply is configured to generate a first potential different from a power supply potential. The driver is configured to be supplied with a second potential different from the first potential and the first potential and output at least one of the first potential and the second potential according to a terminal switching signal. The switch section is configured to switch a connection between a common terminal and a radio frequency terminal according to an output of the driver. The compensator is configured to detect a change in the terminal switching signal and supply electric charges having a polarity the same as a polarity of the first potential to the driver for compensating the first potential.

Embodiments will now be described with reference to the drawings. In the specification and drawings, components similar to those described or illustrated in a drawing thereinabove are marked with like reference numerals, and a detailed description is omitted as appropriate.

### First Embodiment

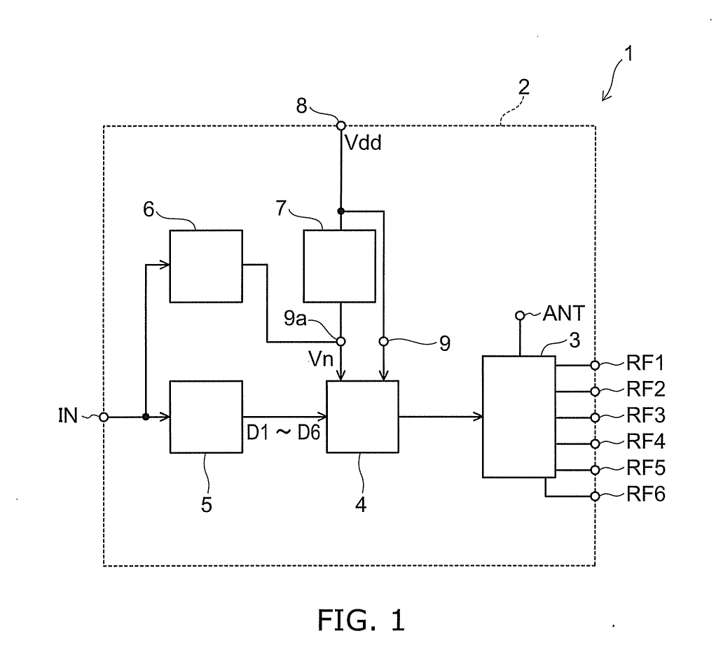

FIG. 1 is a block diagram illustrating a configuration of a semiconductor switch according to a first embodiment.

As illustrated in FIG. 1, a semiconductor switch 1 is provided with a common terminal ANT, radio frequency terminals RF1 to RF6, and a switch section 3 that switches connections between the terminals on a SOI substrate 2. The switch section 3 switches connections between the terminals according to control signals outputted from a driver 4. The switch section 3 can be formed of MOSFETs, for example.

An interface 5 decodes a terminal switching signal IN, and outputs the decoded signal to the driver 4. The terminal switching signal IN inputted to the interface 5 may be any of parallel data and serial data.

The driver 4 generates control signals according to the terminal switching signal IN inputted trough the interface 5. The driver 4 is supplied with a first potential Vn as an Off-potential Voff and a second potential as an ON-potential Von. Here, the ON-potential Von is a high-level potential of the control signals. The ON-potential Von is a potential applied to the gate of each FET in the switch section 3, for example, for turning on each FET, at which the ON resistance thereof has a sufficiently low value.

The Off-potential Voff is a low-level potential of the control signals. The Off-potential is a potential that is applied to the gate of each FET at the switch section 3, for example, for turning off each FET and that can sufficiently maintain the OFF state even a radio frequency signal is superposed.

In the semiconductor switch 1, for the second potential, a positive power supply potential Vdd supplied to a power supply terminal 8 is supplied to the driver 4 through a high-potential power supply terminal 9. The first potential Vn is supplied from a power supply 7 provided on the SOI substrate 2 through a low-potential power supply terminal 9a. The power supply 7 generates a negative first potential Vn from the power supply potential Vdd.

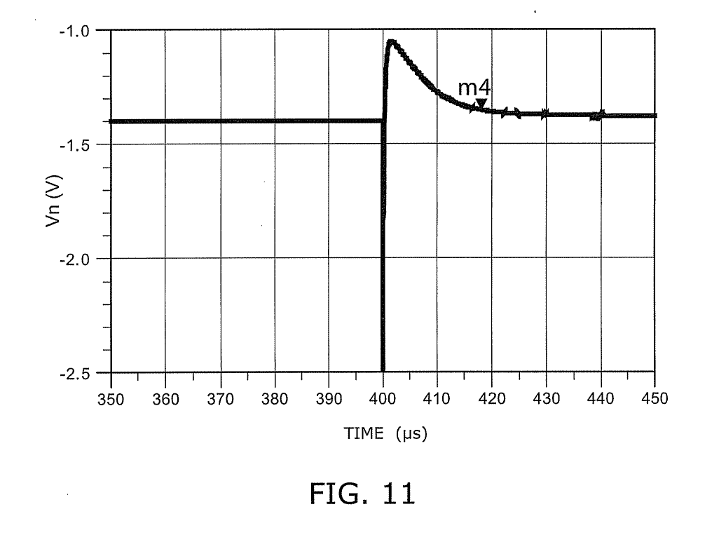

As described in FIG. 11, when the switch section 3 switches connections between the terminals according to a change in the terminal switching signal IN, the first potential Vn varies. The stationary value of the first potential Vn is set equal to the aforementioned Off-potential Voff.

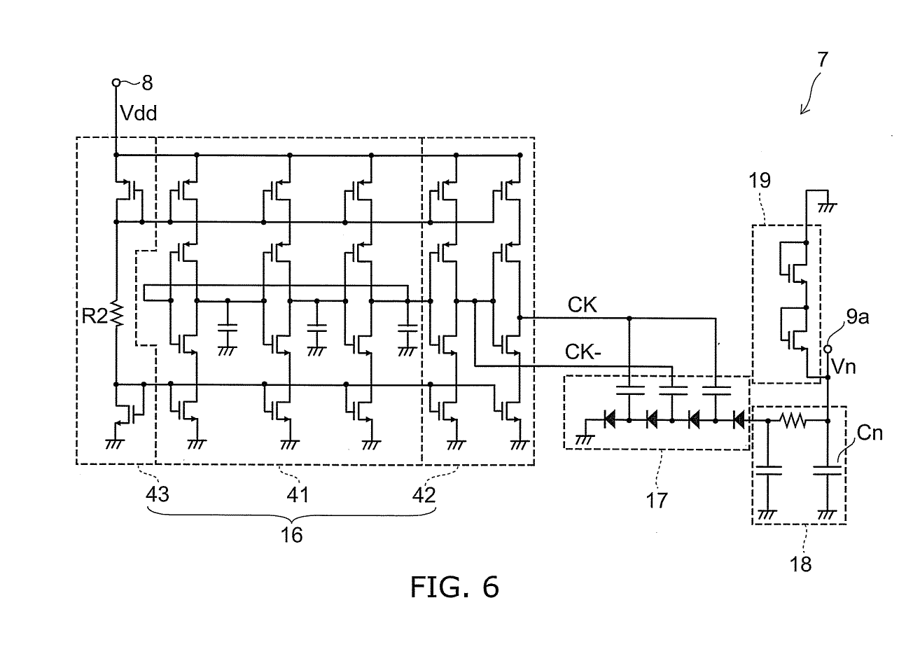

A compensator 6 is connected to the low-potential power supply terminal 9. As described in FIG. 6, the compensator 6 detects a change in the terminal switching signal IN, and supplies electric charges having the same polarity as the polarity of the first potential Vn to the driver 4 for compensating the first potential Vn. In FIG. 1, the first potential Vn is negative. The compensator 6 supplies electric charges with negative polarity to the driver 4.

The semiconductor switch 1 is a SP6T (Single-Pole 6-Throw) switch that switches connections between the common terminal ANT and the radio frequency terminals RF1 to RF6 according to the terminal switching signal IN. The switch section 3 has a multipart, and can be used for multimode and multiband wireless devices or the like. In the explanation below, the configuration of the SP6T switch is illustrated for explanation. However, the switch section 3 can be similarly applied to switches in the other configurations, and the switch section 3 can also configure a wPkT switch (w is a natural number, and k is a natural number of two or more).

Next, each of sections and components will be described.

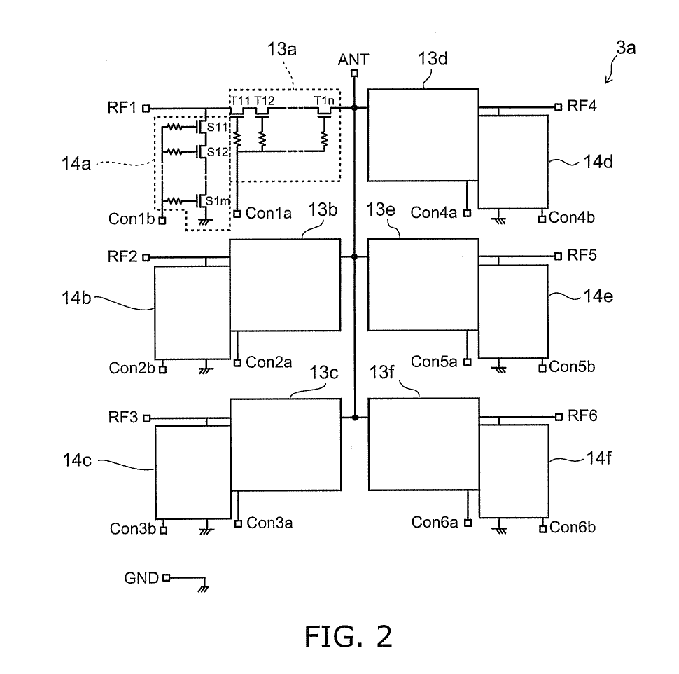

FIG. 2 is a circuit diagram illustrating a configuration of a switch section of the semiconductor switch shown in FIG. 1.

As illustrated in FIG. 2, in a switch section 3a, the configuration of the SP6T switch is illustrated. First switch elements 13a, 13b, 13c, 13d, 13e, and 13f are connected between the common terminal ANT and the radio frequency terminals RF1, RF2, RF3, RF4, RF5, and RF6, respectively. When the first switch elements 13a, 13b, 13c, 13d, 13e, and 13f are individually turned on, between the common terminal ANT and the radio frequency terminals RF1, RF2, RF3, RF4, RF5, and RF6 conduct.

In the first switch element 13a, through FETs T11, T12 to Tin in n stags (n is a natural number) are connected in series to each other. A control signal Con1a is inputted to the gates of the through FETs T11, T12 to Tin through a resister for preventing leakage of radio frequency. The first switch elements 13b, 13c, 13d, 13e, and 13f each have the same configuration as the configuration of the first switch element 13a. Control signals Con2a, Con3a, Con4a, Con5a, and Con6a are inputted to the first switch elements 13b, 13c, 13d, 13e, and 13f, respectively.

Second switch elements 14a, 14b, 14c, 14d, 14e, and 14f are connected between the radio frequency terminals RF1, RF2, RF3, RF4, RF5, and RF6 and a ground GND, respectively. The second switch elements 14a, 14b, 14c, 14d, 14e, and 14f let a leakage current flowing through the radio frequency terminals RF1, RF2, RF3, RF4, RF5, and RF6 go to the ground GND when the first switch elements 13a, 13b, 13c, 13d, 13e, and 13f are off for improving isolation between the radio frequency terminals RF1, RF2, RF3, RF4, RF5, and RF6.

In the second switch element 14a, shunt FETs S11, S12 to Sim in m stages (m is a natural number) are connected in series to each other. A control signal Con1b is inputted to the gates of the shunt FETs S11, S12 to Sim through a resister for preventing leakage of radio frequency. The second switch elements 14b, 14c, 14d, 14e, and 14f each have the same configuration as the configuration of the second switch element 14a. Control signals Con2b, Con3b, Con4b, Con5b, and Con6b are inputted to the second switch elements 14b, 14c, 14d, 14e, and 14f, respectively.

For example, when the terminals are controlled as below, between the radio frequency terminal RF1 and the common terminal ANT conducts. The first switch element 13a between the radio frequency terminal RF1 and the common terminal ANT is turned on, and the second switch element 14a between the radio frequency terminal RF1 and the ground GND is turned off. Namely, the through FETs T11, T12 to Tin in the first switch element 13a are all turned on, and the shunt FETs S11, S12 to Sim in the second switch element 14a are all turned off.

At the same time, the first switch elements 13b, 13c, 13d, 13e, and 13f between the other radio frequency terminals RF2, RF3, RF4, RF5, and RF6 and the common terminal ANT are all turned off, and the second switch elements 14b, 14c, 14d, 14e, and 14f between the other radio frequency terminals RF2, RF3, RF4, RF5, and RF6 and the ground GND are all turned on. Namely, the through FETs in the first switch elements 13b, 13c, 13d, 13e, and 13f are all turned off, and the shunt FETs in the second switch elements 14b, 14c, 14d, 14e, and 14f are all turned on.

In the aforementioned case, the control signal Con1a is set at the ON-potential Von, the control signals Con2b, Con3b, Con4b, Con5b, and Con6b at the ON-potential Von, the control signal Con1b at the Off-potential Voff, and the control signals Con2a, Con3a, Con4a, Con5a, and Con6a at the Off-potential Voff.

As described above, the ON-potential Von is a potential that makes each FET in a conducting state, at which the ON resistance thereof has a sufficiently low value. The Off-potential Voff is a potential that makes each FET in a blocking state and that can sufficiently maintain the blocking state even an RF signal is superposed.

When the ON-potential Von is lower than a desired potential (2.4 V, for example), the ON resistance of the FET in the conducting state is increased to cause an insertion loss to deteriorate as well as to cause an increase in a distortion (an ON distortion) produced in the FET in the conducting state.

When the Off-potential Voff is higher than a desired potential, the maximum allowable input power is decreased as well as a distortion (an OFF distortion) produced in the FET in the blocking state is increased in normal input. However, the OFF distortion also deteriorates if the Off-potential Voff is too large on the negative side. The Off-potential Voff has an optimum point.

In a multiport switch like the semiconductor switch 1, there is one first switch element in the ON state, whereas there are the number of ports minus one of the first switch elements in the OFF state, so that an OFF distortion becomes a problem. For example, in the GSM standard, the allowable maximum value of input power is as large as 35 dBm, and it is important to suppress a harmonic distortion at this time. It is demanded that the specified value of the harmonic distortion be below −80 dBc, for example.

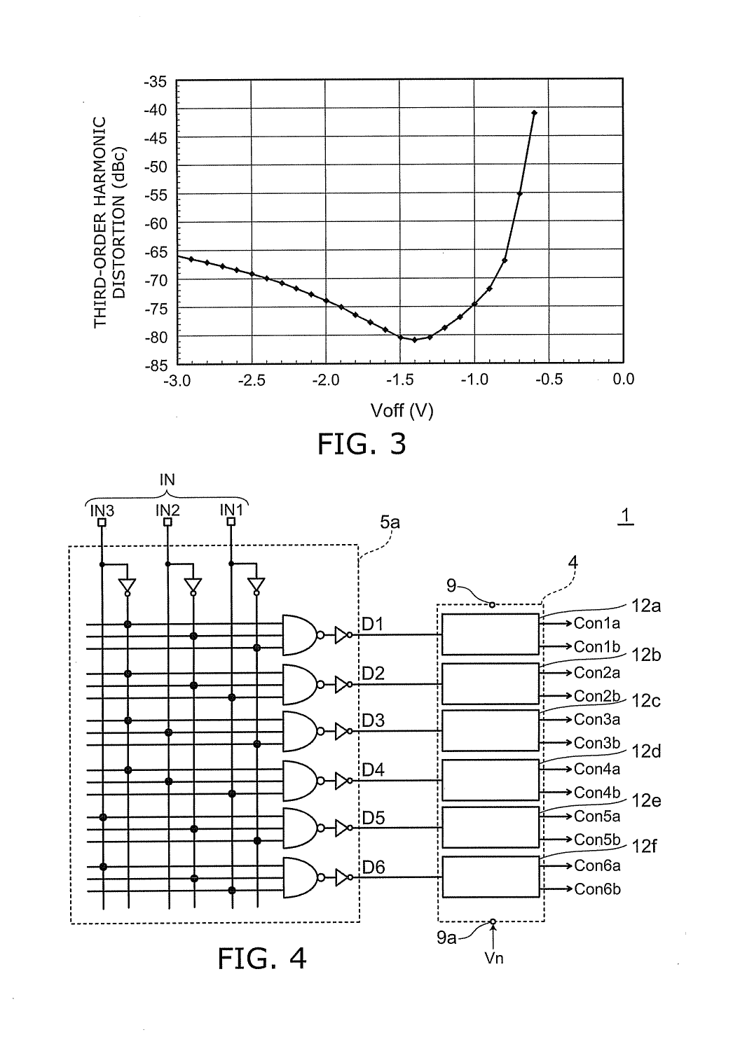

FIG. 3 is a characteristic diagram showing the dependence of a third-order harmonic distortion on the Off-potential Voff of the switch section shown in FIG. 2.

FIG. 3 shows the dependence of a third-order harmonic distortion on the Off-potential Voff where the input power is at 35 dBm, and the numbers of stages of the through FETs and the shunt FETs in the switch section 3 are n=m=16.

When the Off-potential Voff is at a potential of −1.4 V, the third-order harmonic distortion takes a minimum value (−81 dBc). When an Off-potential Voff varys from the optimum value, the OFF distortion such as a third-order harmonic distortion deteriorates.

A control signal to control the gate potential of each FET in the switch section 3a to the aforementioned Off-potential Voff or ON-potential Von is generated at the driver 4 shown in FIG. 1.

FIG. 4 is a circuit diagram illustrating a configuration of an interface and a driver of the semiconductor switch shown in FIG. 1.

As illustrated in FIG. 4, an interface 5a decodes an inputted terminal switching signal IN. The semiconductor switch 1 includes the switch section 3 in SP6T. Thus, the interface 5a decodes a three-bit terminal switching signal IN. Here, the terminal switching signal IN is formed of three bits, IN1, IN2, and IN3, from the LSB side. The interface 5a outputs signals D1 (LSB), D2, D3, D4, D5, and D6 (MSB) of six bits.

In the case where a six-bit signal is inputted as the terminal switching signal IN, or in the case where the number of terminals of the switch section 3 is two, the interface 5a is unnecessary. In FIG. 4, although the configuration is illustrated in the case where the terminal switching signal IN is parallel signals, it is possible to provide the similar configuration in the case of serial signals. It is noted that the power supply potential Vdd is supplied to the interface 5a.

The signals (the decode signal) D1 to D6 decoded at the interface 5a are inputted to the driver 4.

The driver 4 is formed of six level shifters 12a to 12f. As illustrated in FIG. 1, the high-potential power supply terminal 9 of the driver 4 is connected to the power supply terminal 8. Thus, the power supply potential Vdd is supplied as the second potential to the driver 4 through the high-potential power supply terminal 9. A negative first potential Vn is supplied to the driver 4 through the low-potential power supply terminal 9a.

The level shifters 12a to 12f receives the decode signals D1 to D6, level-shift the high-level potential of the signals to the power supply potential Vdd (the second potential) and the low-level potential to the first potential Vn, and output the signals as the control signals Con1a to Con6a and Con1b to Con6b.

The level shifter 12a receives the signal D1 that is the LSB of the decode signals D1 to D6, and outputs the control signals Con1a and Con1b. The level shifters 12b to 12f receive one bit of the decode signals D1 to D6, respectively, and output the control signals Con2a and Con2b to Con6a and Con6b.

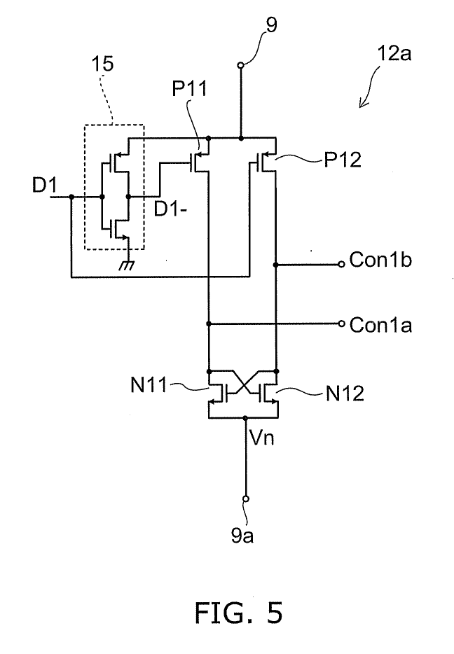

FIG. 5 is a circuit diagram illustrating a configuration of a level shifter.

In FIG. 5, the configuration of the level shifter 12a constituting the driver 4 is illustrated. The other level shifters 12b to 12f constituting the driver 4 are similarly configured as the level shifter 12a.

In the level shifter 12a, an inverter 15 of a CMOS (Complementary Metal Oxide Semiconductor) generates an inverting signal D1− of the signal D1 that is the LSB of the decode signal. The signals D1 and D1− are inputted as differential signals to a pair of N-channel MOSFETs (in the following, NMOS) N11 and N12, and a pair of P-channel MOSFETs (in the following, PMOS) P11 and P12.

The signals D1− and D1 are inputted to the gates of the PMOS P11 and the PMOS P12, respectively. The power supply potential Vdd is supplied to the sources of the PMOS P11 and the PMOS P12 through the high-potential power supply terminal 9.

The drain of the PMOS P11 is connected to the drain of the NMOS N11. The control signal Con1a is outputted from the drain of the PMOS P11 and the drain of the NMOS N11. The drain of the PMOS P12 is connected to the drain of the NMOS N12. The control signal Con1b is outputted from the drain of the PMOS P12 and the drain of the NMOS N12. The control signals Con1a and Con1b are outputted as differential signals from the level shifter 12a.

The sources of the NMOS N11 and the NMOS N12 are connected to the low-potential power supply terminal 9a. The gate of the NMOS N11 is connected to the drain of the NMOS N12. The gate of the NMOS N12 is connected to the drain of the NMOS N11.

The control signal Con1a is supplied to the gates of the through FETs in the first switch element 13a. The control signal Con1b is supplied to the gates of the shunt FETs in the second switch element 14a. The gates are made at the ON-potential Von or the Off-potential Voff according to the terminal switching signal IN (IN1 to IN3).

For example, suppose that the signal D1 is at low level (0 V), the potential of the control signal Con1b is made equal to the power supply potential Vdd (2.4 V, for example), and the potential of the control signal Con1a is made equal to the first potential Vn (−1.5 V, for example). The level shifter 12a outputs the power supply potential Vdd (2.4 V, for example) as the ON-potential Von and the first potential Vn (−1.5 V, for example) as the Off-potential Voff.

It is sufficient that the level shifter 12a can level-shift the decode signals D1 and D1− having the high-level potential at the supply potential Vdd and the low-level potential at a potential of 0 V to the control signals Con1a and Con1b having the high-level potential at the power supply potential Vdd and the low-level potential at the first potential Vn. The level shifter 12a does not necessarily have the configuration shown in FIG. 5, which may have the other configurations. The same thing is applied to the level shifters 12b to 12f.

FIG. 6 is a circuit diagram illustrating a configuration of a power supply of the semiconductor switch shown in FIG. 1.

As illustrated in FIG. 6, the power supply 7 is provided with an oscillator 16, a charge pump 17, a lowpass filter 18, and a clamp circuit 19.

The oscillator 16 is formed of a ring oscillator 41 formed of inverters in odd-numbered stages, an output buffer 42, and a bias circuit 43, and outputs differential clock signals CK and CK−.

The bias circuit 43 supplies biases to the ring oscillator 41 and the output buffer 42. A resistor R2 of the bias circuit 43 regulates a current flowing through the ring oscillator 41 and the output buffer 42.

The charge pump 17 has three diodes serially connected to each other and two capacitors having one end thereof connected between the diodes. The cathode side of the three diodes connected in series is connected to the ground GND, and the anode side is connected to the lowpass filter 18. The differential clock signals CK and CK− are alternately supplied from the oscillator 16 to the other ends of the capacitors.

Electric charges are stored and moved by the differential clock signals CK and CK−, so that a negative voltage is generated at the charge pump 17. The lowpass filter 18 is formed of a resistor and capacitors to remove the output noise of the charge pump 17. The terminal voltage of an output capacitor Cn of the lowpass filter 18 connected to the low-potential power supply terminal 9a is made at the first potential Vn with respect to the ground GND.

The power supply 7 to generate the negative first potential Vn is described. However, a power supply to generate a positive potential higher than the power supply potential Vdd can also be configured similarly.

The clamp circuit 19 is connected between the low-potential power supply terminal 9a and the ground GND to stabilize the first potential Vn. In FIG. 5, for the clamp circuit 19, a configuration is illustrated in which a two-stage NMOS clamp circuit whose diodes are connected. The threshold voltage of each NMOS is at a voltage of −0.7 V, for example, and the first potential Vn is clamped at a potential of −1.4 V. However, it is sufficient that the clamp circuit 19 can stabilize the first potential Vn, and the clamp circuit 19 can also have the other configurations. For example, the clamp circuit 19 may be formed of a regulator using a bandgap reference circuit. In this case, variations in the first potential Vn caused by variations in temperature or device characteristics can also be suppressed.

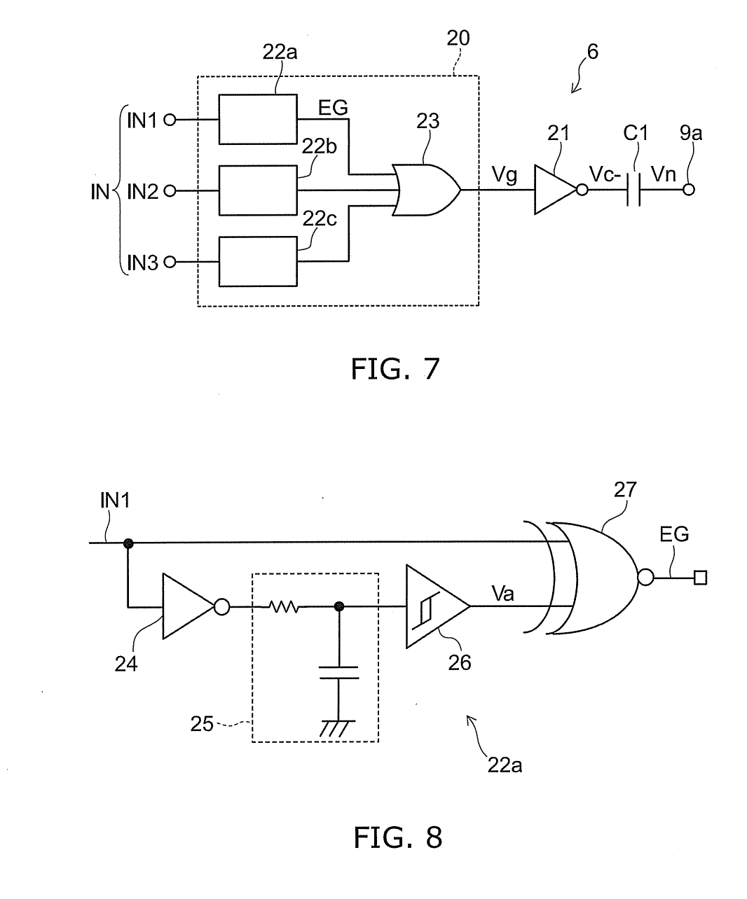

FIG. 7 is a circuit diagram illustrating a configuration of a compensator of the semiconductor switch shown in FIG. 1.

As illustrated in FIG. 7, in the compensator 6, a pulse generator 20 detects changes in the signal IN1 (LSB), IN2, and IN3 (MSB) that are the bits of the terminal switching signal IN using edge detectors 22a, 22b, and 22c. Then, an OR 23 generates the logical sum of outputs of the edge detectors 22a, 22b, and 22c, and outputs the logical sum as a pulse signal Vg.

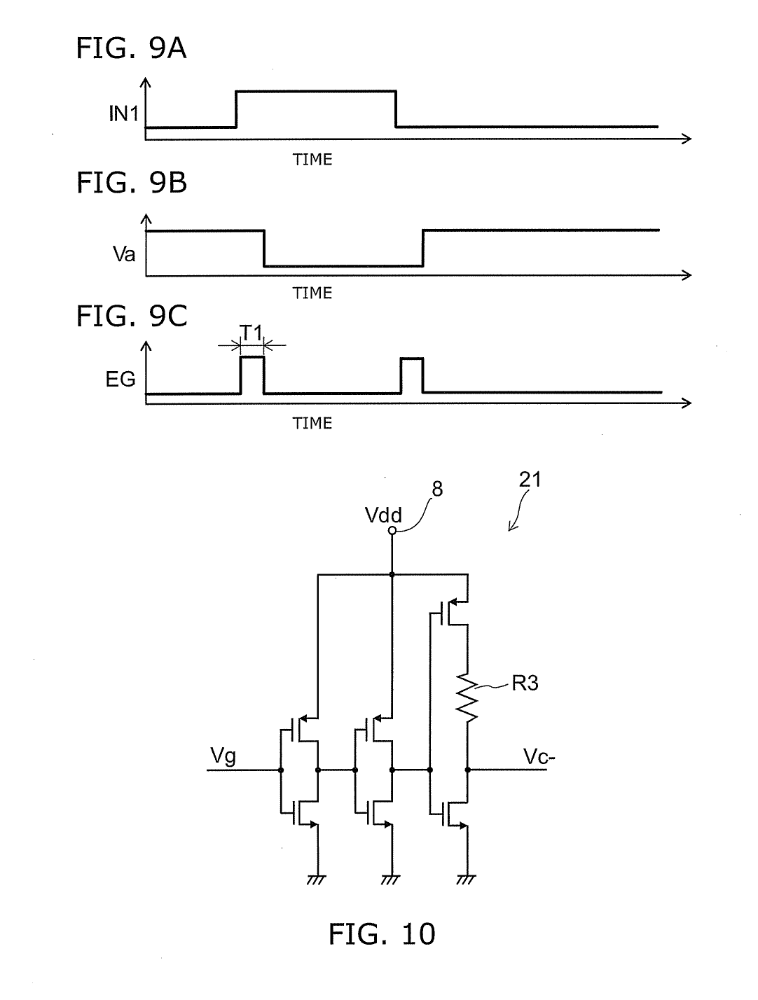

The edge detector 22a can be configured as illustrated in FIG. 8, for example. FIG. 9A, FIG. 9B, and FIG. 9C show timing charts of main signals of the edge detector illustrated in FIG. 8. The edge detectors 22b and 22c have the same configuration as the configuration of the edge detector 22a.

In the edge detector 22a, an inverter 24 generates the NOT of the one-bit terminal switching signal IN1 (LSB) (FIG. 9A), causes the signal to be delayed at a delay circuit 25, and generates a signal Va waveform-shaped at a buffer 26 (FIG. 9B). An EXNOR 27 generates the NOT of an exclusive OR between the terminal switching signal IN1 and the signal Va. A change in the terminal switching signal IN1 is detected in an output signal EG of the EXNOR 27 (FIG. 9C).

As described above, the pulse generator 20 detects changes in the terminal switching signal IN (IN1 to IN3), and generates a pulse signal Vg with a pulse width T1. Here, desirably, the pulse width T1 ranges from 1 μs or more to about 10 μs.

The pulse generator 20 does not necessarily have the configurations shown in FIG. 7 and FIG. 8, and it is sufficient that the pulse generator 20 can detect changes in the terminal switching signal IN (IN1 to IN3) for generating the pulse signal Vg with the pulse width T1.

An amplifier 21 inverts and amplifies the pulse signal Vg. A capacitive element C1 is connected between the amplifier 21 and the driver 4 through the low-potential power supply terminal 9a. The amplifier 21 charges or discharges the capacitive element C1. When charging or discharging the capacitive element C1, electric charges are moved between the driver 4 and the power supply 7 through the low-potential power supply terminal 9a.

The amplifier 21 generates a negative pulse that relatively quickly decreases from high level to low level when receiving the pulse signal Vg and relatively slowly increases from low level to high level after the pulse width T1 of the pulse signal Vg elapses, and the amplifier 21 outputs the negative pulse as an output signal Vc−.

For example, an output resistance when the potential (the output potential) of the output signal Vc− is increased is made greater than an output resistance when the potential of the output signal Vc− is decreased, so that the aforementioned negative pulse can be generated. Namely, when the terminal switching signal IN is changed to increase the pulse signal Vg, the output resistance of the amplifier 21 is small. Thus, the output signal Vc− steeply decreases. However, when the pulse signal Vg decreases, the output resistance of the amplifier 21 is large, and the signal Vc− gently increases at a time constant T2. Here, a time constant longer than the aforementioned pulse width T1 is desirable for the time constant T2, ranging from 10 μs or more to about 100 μs, for example.

The amplifier 21 can be configured as illustrated in FIG. 10, for example. The amplifier 21 is formed of inverters in three stages, in which a resistor R3 is connected between the drain of a PMOS in the output stage and an output terminal. Although the configuration of the inverter in three stages is illustrated in FIG. 10, the number of stages is optional if odd-number stages.

Desirably, a time constant determined by the resistor R3 and the capacitive element C1 ranges from 10 μs or more to about 100 μs as described above. For example, the time constant becomes 100 μs, where the resistance of the resistor R3 is 1 MΩ, and the capacitance of the capacitive element C1 is a capacitance of 100 pF.

### COMPARATIVE EXAMPLE

The operation of the compensator 6 is more apparent by the comparison with in the case where the compensator 6 is not provided.

FIG. 17 is an equivalent circuit diagram illustrative of variations in a first potential Vn in a comparative example.

In FIG. 17, a switch section 3 is shown by a resistor Rg and a gate capacitance Cg. A level shifter of a driver 4 is shown by a high-side switch HS and a low-side switch LS. A power supply 7 is shown by an output capacitor Cn.

FIG. 17 shows a moment at which the connection of the switch section is switched from a state in which the high-side switch HS is in the ON state and the low-side switch LS is in the OFF state to a state in which the high-side switch HS is in the OFF state and the low-side switch LS is in the ON state.

Here, the driver 4 is supplied with a power supply potential Vdd through a high-potential power supply terminal 9, and a first potential Vn from a power supply 7 through a low-potential power supply terminal 9a. The load of the driver 4 is the gate of each FET constituting the switch section 3, and modeled with the resistor Rg connected to the gate and the gate capacitance Cg.

For example, in an antenna switch, since it is necessary to pass a high-power signal at a low loss, the total gate width of the FETs in the switch section 3 is large and the number of connection stages of FETs is also great. Thus, the total sum of the gate capacitance Cg to drive is as large as a few tens pF or more.

On the other hand, generally, the current supply capacity of an IC built-in charge pump is as low as a few μA, and the charge pump does not have the power to charge and discharge a capacitor with about a few tens pF at high speed. Thus, the output capacitor Cn is provided in order to supply a transient current. A capacitance of a few hundreds pF or more is necessary for the capacitance of the output capacitor Cn.

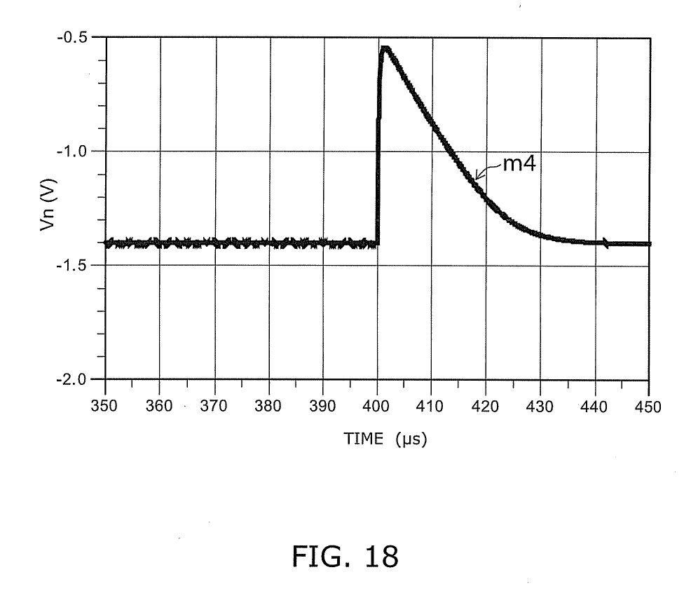

FIG. 18 is a waveform diagram showing time variations in the first potential Vn of the semiconductor switch of the comparative example.

In FIG. 18, the first potential Vn is indicated on the vertical axis, and time is indicated on the horizontal axis, showing the waveform of the first potential Vn when the switch section of the semiconductor switch of the comparative example is switched at time=400 μs. Here, the semiconductor switch of the comparative example has the configuration in which the compensator 6 is removed from the semiconductor switch 1 according to the first embodiment shown in FIG. 1. The capacitance of the output capacitor Cn is 150 pF.

At a moment at which the connection of the switch section is switched, the gate capacitance Cg charged at the power supply potential Vdd is charged by the power supply 7 through the low-potential power supply terminal 9a, so that the first potential Vn is increased instantaneously (the absolute value is decreased). After that, the value of the first potential Vn asymptotically approaches the stationary value at a time constant according to the current capacity of the charge pump of the power supply 7.

In the GSM standard, for example, it is likely that radio frequency power is inputted after 18 μs since switched. The first potential Vn at that point in time (a point m4 in FIG. 18) is a potential of −1.15 V, and a third-order harmonic distortion at that time is −77 dBc from FIG. 3. Suppose that the specified value of the third-order harmonic distortion is −80 dBc, the specified value is not satisfied.

An instantaneous increase in the first potential Vn in switching can be suppressed, if the value of the capacitance of the output capacitor Cn can take a greater value. However, in order to obtain the effect, a large capacitance of 1 nF or more is necessary. This large capacitance increases the IC chip area as well as prolongs a time period for which the first potential Vn reaches a desired value after power application. It is likely to exceed a specified time, for example, (500 μs, for example).

Next, the operation of the compensator 6 will be described. In a steady state in which the terminal switching signal IN is not changed, the pulse generator 20 outputs the pulse signal Vg at a low-level potential. The amplifier 21 outputs the signal Vc− at a high-level potential in the steady state. The high-level potential is the power supply potential Vdd, and the low-level potential is a ground potential of 0 V, where the power supply potential Vdd=2.7 V, and the first potential Vn=−1.4 V.

Electric charges are charged in the capacitive element C1 at a potential difference between the output potential Vc−=2.7 V and the first potential Vn=−1.4 V in the steady state.

Next, such situations are considered that the terminal switching signal IN is changed to cause the switching operation of the switch section 3a.

As described above, in changing the terminal switching signal IN, the pulse generator 20 generates the pulse signal Vg with the pulse width T1, and at the same time at the time of switching the terminals, the output signal Vc− of the amplifier 21 steeply decreases from high level to low level. At the same time as the steep decrease, the power supply 7 outputted from the first potential Vn tries to steeply increase (the absolute value is decreased), as described above.

However, in the compensator 6, one end of the capacitive element C1 is connected to the low-potential power supply terminal 9a, and the other end is connected to the amplifier 21. Since the potential (the output signal Vc−) of the other end of the capacitive element C1 steeply decreases, an increase in the first potential Vn that is the potential of one end of the capacitive element C1 is suppressed. Namely, since the output signal Vc− of the amplifier 21 steeply decreases, the capacitive element C1 absorbs positive electric charges from the driver 4 through the low-potential power supply terminal 9a.

As described above, the capacitive element C1 supplies electric charges (negative electric charges) having the same polarity as the polarity of the first potential Vn to the driver 4 for compensating the first potential Vn.

After the pulse width T1 elapses since the switching operation, the output signal Vc− of the amplifier 21 tries to return to high level. However, the time constant T2 of the output signal Vc− is set as long as about 100 μs, so that the first potential Vn is not prevented from asymptotically approaching a desired value because of the action of the charge pump.

FIG. 11 is a waveform diagram showing time variations in a first potential Vn of the semiconductor switch according to the first embodiment.

FIG. 11 shows the result according to the circuit simulation of the semiconductor switch 1.

The first potential Vn at a point in time after 18 μs since switched (a point m4 shown in FIG. 11) is at a potential of −1.352 V, and it is revealed from a graph shown in FIG. 3 that a third-order harmonic distortion is −80 dBc or less.

In the simulation, the capacitance of the output capacitor Cn is 50 pF, and the capacitance of the capacitive element C1 is 100 pF. A combined capacitance of the output capacitor Cn and the capacitive element C1 is equal to a capacitance of 150 pF of the output capacitor Cn in the comparative example shown in FIG. 17.

As described above, according to the semiconductor switch 1, it is possible to suppress an increase in a distortion in switching the terminals. In addition, it is possible to suppress an increase in the chip area caused by incorporating a large capacitance for downsizing.

In the semiconductor switch 1, the power supply potential Vdd is supplied to the high-potential power supply terminal 9 of the driver 4 through the power supply terminal 8. However, the power supply potential Vdd is not limited to the power supply potential externally supplied through the power supply terminal 8, which may be a potential that an external power supply potential is stabilized. The circuitry configuration of the power supply 7 may be a circuit that generates a negative potential, not necessarily one shown in FIG. 6. The port configuration of the semiconductor switch is not limited to the SP6T, which may be a wPkT (w is a natural number, and k is a natural number of two or more).

### Second Embodiment

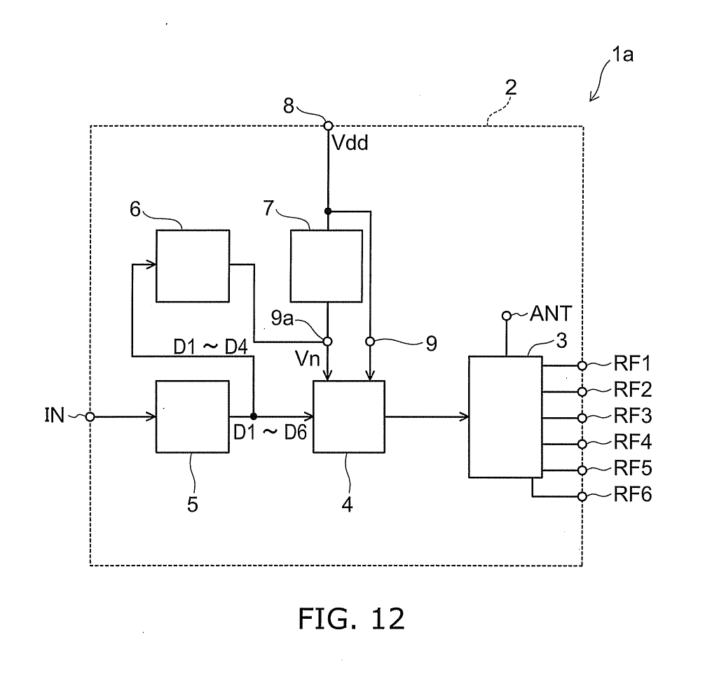

FIG. 12 is a block diagram illustrating a configuration of a semiconductor switch according to a second embodiment.

As illustrated in FIG. 12, in a semiconductor switch 1a, a compensator 6 receives decode signals D1 to D4 that a terminal switching signal IN is decoded at an interface 5. The compensator 6 detects a change in the terminal switching signal IN when the terminal switching signal IN takes a specified value. Points other than this are the same as those in the semiconductor switch 1 shown in FIG. 1. In FIG. 12, a configuration is illustrated in the case where the terminal switching signal IN takes 1 to 4 as specified values.

As described above, it is also possible that the compensator 6 receives only a part of bits of the decode signals D1 to D6. For example, as illustrated in FIG. 12, the compensator 6 can receive bits D1 to D4 of the decode signals D1 to D6 corresponding to radio frequency signals with a large input power as in the GSM standard.

It is possible to suppress an increase in an OFF distortion when switching to a terminal of a radio frequency signal with a large power.

The compensator 6 can receive the bit of a decode signal corresponding to a transmission signal. It is possible to suppress an increase in an OFF distortion when switching to a large power transmission signal as compared with a received signal.

### Third Embodiment

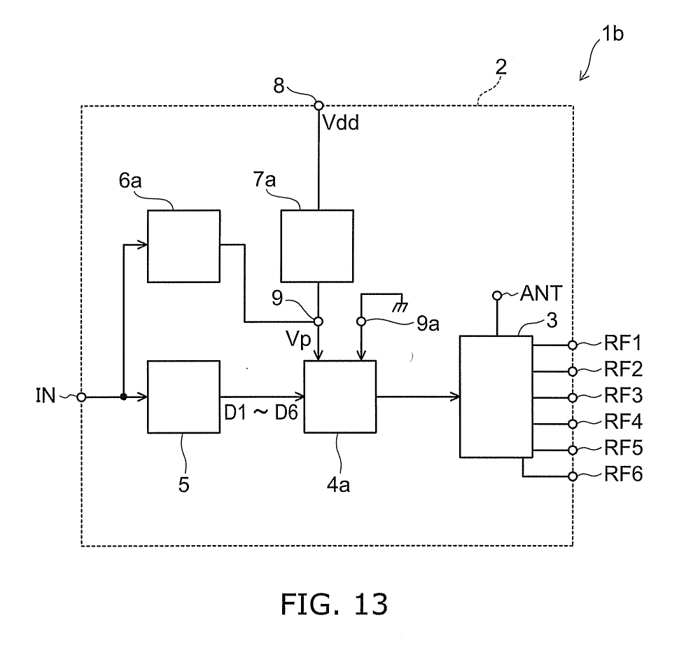

FIG. 13 is a block diagram illustrating a configuration of a semiconductor switch according to a third embodiment.

As illustrated in FIG. 13, in a semiconductor switch 1b, a power supply 7a generates a first potential Vp higher than a positive power supply potential Vdd. A driver 4a is supplied with the first potential Vp as an ON-potential Von through a high-potential power supply terminal 9. The driver 4a is supplied with a second potential as an Off-potential Voff through a low-potential power supply terminal 9a. In FIG. 13, although a ground potential of 0 V is supplied as the second potential, a negative potential may be supplied.

The driver 4a generates a control signal that a signal (a decode signal) decoded at an interface 5 is level-shifted in such a way that the high-level potential is level-shifted to the first potential Vp and the low-level potential to the ground potential (the second potential).

The driver 4a can be similarly configured as the level shifter 12a shown in FIG. 5, for example.

When the switch section 3 switches connections between the terminals according to a change in a terminal switching signal IN, the first potential Vp varies. The stationary value of the first potential Vp is set equal to the aforementioned ON-potential Von.

The power supply 7a that generates the first potential Vp can be configured in such a way that the diodes of the charge pump 17 of the power supply 7 shown in FIG. 6, for example, are set in the reverse direction.

A compensator 6a is connected to the high-potential power supply terminal 9. Consequently, the compensator 6a detects a change in the terminal switching signal IN, and supplies electric charges having the same polarity as the polarity of the first potential Vp to the driver 4a for compensating the first potential Vp. In FIG. 13, the first potential Vp is positive. The compensator 6a supplies positive electric charges to the driver 4a.

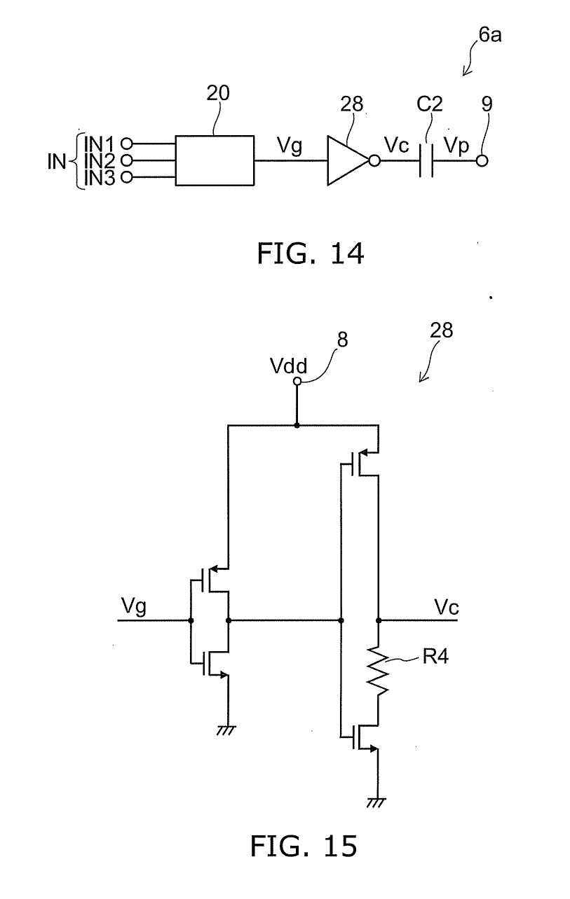

FIG. 14 is a circuit diagram illustrating a configuration of a compensator of the semiconductor switch shown in FIG. 13.

As illustrated in FIG. 14, the compensator 6a has a configuration in which the amplifier 21 and the capacitive element C1 of the compensator 6 shown in FIG. 7 are replaced by an amplifier 28 and a capacitive element C2. A pulse generator 20 is the same as that in the compensator 6.

The pulse generator 20 detects a change in the terminal switching signal IN (IN1, IN2, and IN3), and outputs the change as a pulse signal Vg.

The amplifier 28 amplifies the pulse signal Vg in phase. The capacitive element C2 is connected between the amplifier 28 and the driver 4a through the high-potential power supply terminal 9. The amplifier 28 charges or discharges the capacitive element C2. When the capacitive element C2 is charged or discharged, electric charges are moved between the driver 4a and the power supply 7a through the high-potential power supply terminal 9.

The amplifier 28 generates a positive pulse that relatively quickly increases from low level to high level when receiving the pulse signal Vg and relatively slowly decreases from high level to low level after a pulse width T1 of the pulse signal Vg elapses, and outputs the positive pulse as an output signal Vc.

For example, an output resistance when the potential (the output potential) of the output signal Vc is decreased is increased more than an output resistance when the potential of the output signal Vc is increased, so that the aforementioned positive pulse can be generated. Namely, when the terminal switching signal IN is changed to increase the pulse signal Vg, the output resistance of the amplifier 28 is small. Thus, the output signal Vc of the amplifier 28 steeply increases. However, when the pulse signal Vg decreases, the output resistance of the amplifier 28 is large, and the signal Vc gently decreases at a time constant T2. Here, desirably, the time constant T2 is longer than the aforementioned pulse width T1, for example, which ranges from 10 μs or more to about 100 μs.

The amplifier 28 can be configured as illustrated in FIG. 15, for example. The amplifier 28 is formed of inverters in two stages, in which a resistor R4 is connected between the drain of an NMOS in the output stage and an output terminal. In FIG. 15, although the configuration of the inverters in two stages is illustrated, the number of stages is optional if even-numbered stages.

Desirably, a time constant determined by the resistor R4 and the capacitive element C2 ranges from 10 μs or more to about 100 μs, as described above. For example, the time constant becomes 100 μs, where the resistance of the resistor R4 is 1 MΩ, and the capacitance of the capacitive element C2 is a capacitance of 100 pF.

In the operation of the compensator 6a, since the first potential Vp is decreased at a moment at which the connection of the switch section is switched, the operation of the compensator 6a is the same as the operation of the compensator 6 except that the first potential Vp is compensated in the direction to increase the first potential Vp.

In a steady state in which the terminal switching signal IN is not changed, the pulse generator 20 outputs the pulse signal Vg at low level. The amplifier 28 outputs the signal Vc at low level in the steady state. The low-level potential is the ground potential of 0 V, and the high-level potential is the power supply potential Vdd.

Electric charges are charged in the capacitive element C2 at a potential difference between the output potential Vc=0 V and the first potential Vp in the steady state.

In changing the terminal switching signal IN, the pulse generator 20 generates the pulse signal Vg with the pulse width T1, and at the same time at the time of switching the terminals, the output signal Vc of the amplifier 21 steeply increases from low level to high level. At the same time as the steep increase, the first potential Vp outputted from the power supply 7a tries to steeply decrease as described above.

However, in the compensator 6a, one end of the capacitive element C2 is connected to the driver 4a through the high-potential power supply terminal 9, and the other end is connected to the amplifier 28. Since the potential (the output signal Vc) of the other end of the capacitive element C2 steeply increases, an increase in the first potential Vp that is the potential of one end of the capacitive element C2 is suppressed. Namely, since the output signal Vc of the amplifier 28 steeply increases, the capacitive element C2 supplies positive electric charges to the driver 4 through the high-potential power supply terminal 9.

As described above, the capacitive element C2 supplies electric charges (positive electric charges) having the same polarity as the polarity of the first potential Vp to the driver 4a for compensating the first potential Vp.

After the pulse width T1 elapses since the switching operation, the output signal Vc of the amplifier 28 tries to return to low level. However, since the time constant T2 of the output signal Vc is set as long as about 100 μs, the first potential Vp is not prevented from asymptotically approaching a desired value because of the action of a charge pump.

As described above, according to the semiconductor switch 1b, it is possible to suppress an increase in an ON distortion in switching the terminals. In addition, it is possible to suppress an increase in the chip area caused by incorporating a large capacitance for downsizing.

In the semiconductor switch 1b, the power supply 7a is supplied with the power supply potential Vdd through the power supply terminal 8. However, power supplied to the power supply 7a is not limited to the power supply potential externally supplied through the power supply terminal 8, which may be a potential that an external power supply potential is stabilized. The circuitry configuration of the power supply 7 may be a circuit that generates a positive potential, not limited to the circuitry configuration in which the diodes of the charge pump 17 illustrated in FIG. 6 are reversed. The port configuration of the semiconductor switch is not limited to the SP6T, which may be a wPkT (w is a natural number, and k is a natural number of two or more).

### Fourth Embodiment

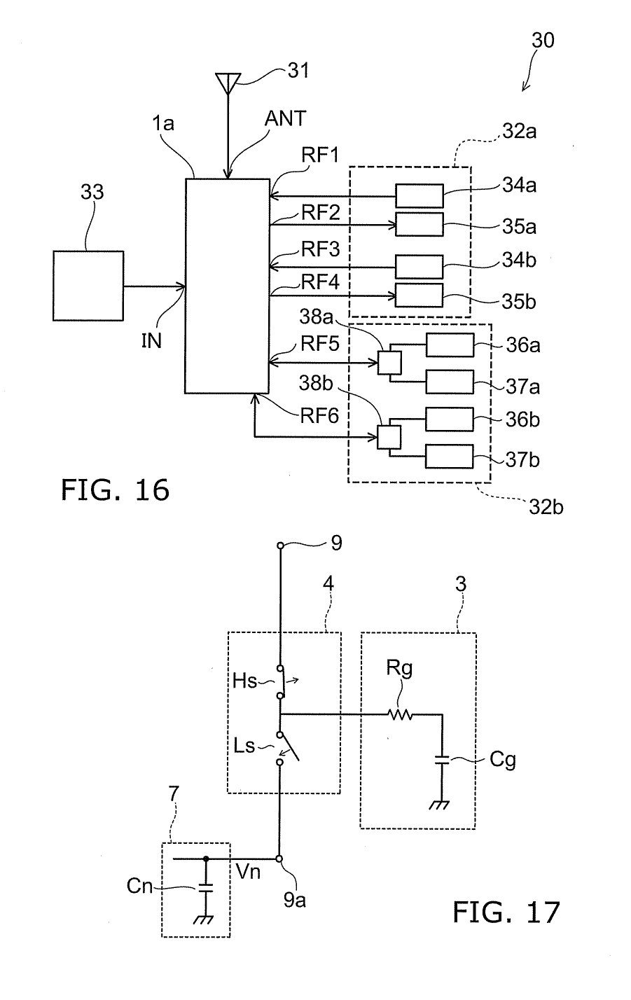

FIG. 16 is a block diagram illustrating a configuration of a wireless device according to a fourth embodiment.

As illustrated in FIG. 16, a wireless device 30 includes a semiconductor switch 1a, an antenna 31, transmitting and receiving circuits 32a and 32b, and a wireless controller 33.

The semiconductor switch 1a is the same as the semiconductor switch 1a shown in FIG. 12 to switch connections between a common terminal ANT and six radio frequency terminals RF1 to RF6 according to a terminal switching signal IN.

In the semiconductor switch 1a as described above, a compensator 6 receives only bits D1 to D4 on the LSB side of decode signals D1 to D6 of the terminal switching signal IN. Consequently, the compensator 6 operates when the terminal switching signal IN takes specified values 1 to 4, and an increase in an OFF distortion in switching connections between the common terminal ANT and the radio frequency terminals RF1 to RF4 is suppressed.

The common terminal ANT is connected to the antenna 31. The radio frequency terminals RF1 to RF6 are connected to the transmitting and receiving circuits 32a and 32b.

The antenna 31 transmits and receives signals in bands corresponding to wireless communications of mobile phones, the GSM standard and the UMTS standard, for example, which transmits and receives radio frequency signals of 800 M to 2 GHz, for example.

The transmitting and receiving circuit 32a has transmitting circuits 34a and 34b and receiving circuits 35a and 35b, and transmits and receives radio frequency signals according to the GSM standard. The transmitting circuit 34a modulates transmission signals formed of audio signals, video signals, and information such as binary data into radio frequency signals according to the GSM standard, and outputs the signals to the radio frequency terminal RF1 of the semiconductor switch 1a. The transmitting circuit 34b modulates transmission signals into radio frequency signals according to the GSM standard, and outputs the signals to the radio frequency terminal RF2 of the semiconductor switch 1a.

The receiving circuit 35a receives radio frequency signals according to the GSM standard inputted from the radio frequency terminal RF3, and demodulates the signals into received signals formed of audio signals, video signals, and information such as binary data or the like. The receiving circuit 35b receives radio frequency signals according to the GSM standard inputted from the radio frequency terminal RF4, and demodulates the received signals.

The transmitting and receiving circuit 32b has transmitting circuits 36a and 36b, receiving circuits 37a and 37b, and duplexers 38a and 38b, and transmits and receives radio frequency signals according to the UMTS standard.

The transmitting circuit 36a modulates transmission signals into radio frequency signals according to the UMTS standard, and outputs the signals to the radio frequency terminal RF5 through the duplexer 38a. The receiving circuit 37a receives the radio frequency signals according to the UMTS standard inputted from the radio frequency terminal RF5 through the duplexer 38a, and demodulates the signals into received signals.

The transmitting circuit 36b modulates transmission signals into radio frequency signals according to the UMTS standard, and outputs the signals to the radio frequency terminal RF6 through the duplexer 38b. The receiving circuit 37b receives the radio frequency signals according to the UMTS standard inputted from the radio frequency terminal RF6 through the duplexer 38b, and demodulates the signals into received signals.

The wireless controller 33 outputs the terminal switching signal IN to the semiconductor switch 1a, and controls connections between the terminals of the semiconductor switch 1a. The wireless controller 33 controls the transmitting and receiving circuits 32a and 32b. Namely, the wireless controller 33 controls the transmitting circuits 34a, 34b, 36a, and 36b, and the receiving circuits 35a, 35b, 37a, and 37b.

For example, in the case where the transmitting circuit 34a of the transmitting and receiving circuit 32a is used to transmit signals, the wireless controller 33 outputs the terminal switching signal IN to the semiconductor switch 1a to connect the common terminal ANT to the radio frequency terminal RF1 of the semiconductor switch 1a.

As described above, in the semiconductor switch 1a, the compensator 6 compensates the first potential Vn in the case where connections between the common terminal ANT and the radio frequency terminals RF1 to RF4 are changed. Thus, the first potential Vn is compensated to a first potential Vn optimum to the GSM standard with a large electric power, and an increase in an OFF distortion is suppressed.

In the semiconductor switch 1a, in the case where the common terminal ANT and the radio frequency terminals RF5 and RF6 are in the conducting state, the compensator 6 does not operate. Thus, the first potential Vn is made to a first potential Vn (the absolute value is small) optimum to the UMTS standard with a relatively small electric power, the first potential Vn being higher than that for the GSM standard, without the influence of the compensator 6.

Thus, according to the wireless device 30, it is possible to decrease the OFF distortion of the semiconductor switch 1a, and to transmit radio frequency signals according to the GSM standard and the UMTS standard from the antenna 31.

In FIG. 16, the configuration is explained in which the semiconductor switch 1a is used for the GSM standard and the UMTS standard. However, the other semiconductor switches 1, 1b, and 1c may be used, and the semiconductor switches 1, 1a, 1b, and 1c may be used for the other wireless communications standards.

In the wireless device 30 shown in FIG. 16, modulation and demodulation are performed in the transmitting circuits 34a, 34b, 36a, and 36b, and the receiving circuits 35a, 35b, 37a, and 37b, respectively. However, such a configuration may be possible that a common modulating and demodulating circuit is provided to output modulation signals to the transmitting circuit and to demodulate signals received from the receiving circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A semiconductor switch comprising:
a power supply configured to generate a first potential different from a power supply potential;
a driver configured to be supplied with a second potential different from the first potential and the first potential and output at least one of the first potential and the second potential according to a terminal switching signal;
a switch section configured to switch a connection between a common terminal and a radio frequency terminal according to an output of the driver; and
a compensator configured to detect a change in the terminal switching signal and supply electric charges having a polarity the same as a polarity of the first potential to the driver for compensating the first potential.

2. The switch according to claim 1,
wherein the compensator includes:
a pulse generator configured to detect a change in the terminal switching signal and generate a pulse signal;
an amplifier configured to amplify the pulse signal; and
a capacitive element connected between the amplifier and the driver.

3. The switch according to claim 2,
wherein the pulse generator generates the pulse signal when the terminal switching signal is set to a specified value.

4. The switch according to claim 1, wherein:
the first potential is negative; and
the amplifier generates a negative pulse that relatively quickly decreases from high level to low level when receiving the pulse signal and relatively slowly increases from low level to high level after a pulse width of the pulse signal elapsing.

5. The switch according to claim 4,
wherein an output resistance of the amplifier when an output signal of the amplifier is increased is greater than an output resistance of the amplifier when an output signal of the amplifier is decreased.

6. The switch according to claim 4,
wherein the amplifier includes an output stage having a resistor connected between a power supply terminal and an output terminal.

7. The switch according to claim 1, wherein:
the first potential is positive;
the second potential is lower than the first potential; and
the amplifier generates a positive pulse that relatively quickly increases from low level to high level when receiving the pulse signal and relatively slowly decreases from high level to low level after a pulse width of the pulse signal elapsing.

8. The switch according to claim 7,
wherein an output resistance of the amplifier when an output signal of the amplifier is decreased is greater than an output resistance of the amplifier when an output signal of the amplifier is increased.

9. The switch according to claim 7,
wherein the amplifier includes an output stage having a resistor connected between a power supply terminal and a ground.

10. The switch according to claim 1,
wherein the power supply includes an output capacitor charged at the first potential.

11. A wireless device comprising:
an antenna configured to emit and receive a radio wave;
a transmitting circuit configured to modulate a transmission signal and send the transmission signal through the antenna;
a receiving circuit configured to demodulate a radio frequency signal received through the antenna;
a semiconductor switch configured to switch and connect the antenna to the transmitting circuit or to the receiving circuit, the semiconductor switch having terminals each connected to the antenna, the transmitting circuit, and the receiving circuit; and
a wireless controller configured to output a terminal switching signal to the semiconductor switch,
the semiconductor switch including:
a power supply configured to generate a first potential different from a power supply potential;
a driver configured to be supplied with a second potential different from the first potential and the first potential and output at least one of the first potential and the second potential according to a terminal switching signal;
a switch section configured to switch a connection between a common terminal and a radio frequency terminal according to an output of the driver; and
a compensator configured to detect a change in the terminal switching signal and supply electric charges having a polarity the same as a polarity of the first potential to the driver for compensating the first potential.

12. The device according to claim 11,
wherein the compensator includes:
a pulse generator configured to detect a change in the terminal switching signal and generate a pulse signal;
an amplifier configured to amplify the pulse signal; and
a capacitive element connected between the amplifier and the driver.

13. The device according to claim 12,
wherein the pulse generator generates the pulse signal when the terminal switching signal is set to a specified value.

14. The device according to claim 11, wherein:
the first potential is negative; and
the amplifier generates a negative pulse that relatively quickly decreases from high level to low level when receiving the pulse signal and relatively slowly increases from low level to high level after a pulse width of the pulse signal elapsing.

15. The device according to claim 14,
wherein an output resistance of the amplifier when an output signal of the amplifier is increased is greater than an output resistance of the amplifier when an output signal of the amplifier is decreased.

16. The device according to claim 14,
wherein the amplifier includes an output stage having a resistor connected between a power supply terminal and an output terminal.

17. The device according to claim 11, wherein:
the first potential is positive;
the second potential is lower than the first potential; and
the amplifier generates a positive pulse that relatively quickly increases from low level to high level when receiving the pulse signal and relatively slowly decreases from high level to low level after a pulse width of the pulse signal elapsing.

18. The device according to claim 17,
wherein an output resistance of the amplifier when an output signal of the amplifier is decreased is greater than an output resistance of the amplifier when an output signal of the amplifier is increased.

19. The device according to claim 17,
wherein the amplifier includes an output stage having a resistor connected between a power supply terminal and a ground.

20. The device according to claim 11,
wherein the power supply includes an output capacitor charged at the first potential.
